(19) United States
(12) Patent Application Publication
(10) Pub. No.: US 2026/0133850 A1
(43) Pub. Date: May 14, 2026

(54) MACHINE LEARNING-BASED FORECASTING SYSTEM WITH DATA STRUCTURE PROCESSING

(71) Applicant: Dell Products L.P., Round Rock, TX (US)

(72) Inventors: Shilna Sasheendran, Bangalore (IN); Renold Raj Devaraj, Bengaluru (IN); Rohitt R. Punjj, Bengaluru (IN)

(21) Appl. No.: 18/944,486

(22) Filed: Nov. 12, 2024

(51) Int. Cl. G06F 9/50; G06N 20/00

(52) U.S. Cl. CPC G06F 9/5083; G06N 20/00

(57) ABSTRACT

Methods, apparatus, and processor-readable storage media for machine learning-based forecasting systems with data structure processing are provided herein. An example computer-implemented method includes processing demand data for multiple resources into one or more data structures; computing temporal-based similarity measures across at least a portion of the demand data in the data structure(s); determining, for a given one of the resources, at least one similar resource from the resources based on the temporal-based similarity measures; training one or more machine learning techniques using portions of the demand data pertaining to the given resource and the at least one similar resource, and portions of the temporal-based similarity measures; and performing one or more automated actions based at least in part on the one or more trained machine learning techniques.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Resource demand forecasting can provide inputs to various resource-related activities, security and/or risk evaluations, etc. However, conventional resource forecasting techniques often result in errors and resource wastage and/or loss.

### SUMMARY

Illustrative embodiments of the disclosure provide machine learning-based forecasting systems with data structure processing.

An exemplary computer-implemented method includes processing demand data for multiple resources into one or more data structures, and computing temporal-based similarity measures across at least a portion of the demand data in the one or more data structures. The method also includes determining, for a given one of the multiple resources, at least one similar resource from the multiple resources based at least in part on the computed temporal-based similarity measures. Additionally, the method includes training one or more machine learning techniques using portions of the demand data, in the one or more data structures, pertaining to the given one resource and the at least one similar resource, and portions of the computed temporal-based similarity measures between the given one resource and the at least one similar resource. Further, the method also includes performing one or more automated actions based at least in part on the one or more trained machine learning techniques.

Illustrative embodiments can provide significant advantages relative to conventional resource forecasting techniques. For example, problems associated with errors and resource wastage and/or loss are overcome in one or more embodiments through implementing a machine learning-based resource forecasting system in conjunction with temporal-based similarity measure computations.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing a machine learning-based forecasting system with data structure processing in an illustrative embodiment.

FIG. 2 shows an example workflow in accordance with an illustrative embodiment.

FIG. 3 shows an example workflow in accordance with an illustrative embodiment.

FIG. 4 shows example pseudocode for implementing at least a portion of a machine learning forecasting model in an illustrative embodiment.

FIG. 5 is a flow diagram of a process for implementing a machine learning-based forecasting system with data structure processing in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

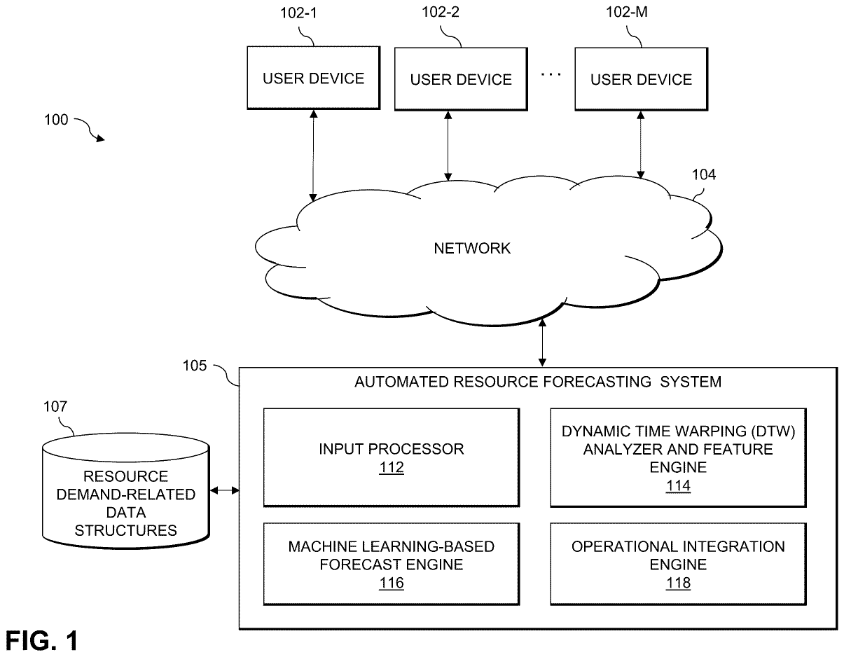

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated resource forecasting system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated resource forecasting system 105 can have one or more resource demand-related data structures 107 configured to store data pertaining to demand time series data for various resources, dynamic time warping (DTW) distance values and alignment path values associated with various resources, forecast data for various resources, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The resource demand-related data structures 107 in the present embodiment are implemented using one or more storage systems associated with the automated resource forecasting system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated resource forecasting system 105 are one or more input-output devices, which illustratively comprise keyboards, displays or other types of input-output devices in any combination. Such input-output devices can be used, for example, to support one or more user interfaces to the automated resource forecasting system 105, as well as to support communication between the automated resource forecasting system 105 and other related systems and devices not explicitly shown.

Additionally, the automated resource forecasting system 105 in the FIG. 1 embodiment is assumed to be implemented using at least one processing device. Each such processing device generally comprises at least one processor and an associated memory, and implements one or more functional modules for controlling certain features of the automated resource forecasting system 105.

More particularly, the automated resource forecasting system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated resource forecasting system 105 to communicate over the network 104 with the user devices 102, and illustratively comprises one or more conventional transceivers.

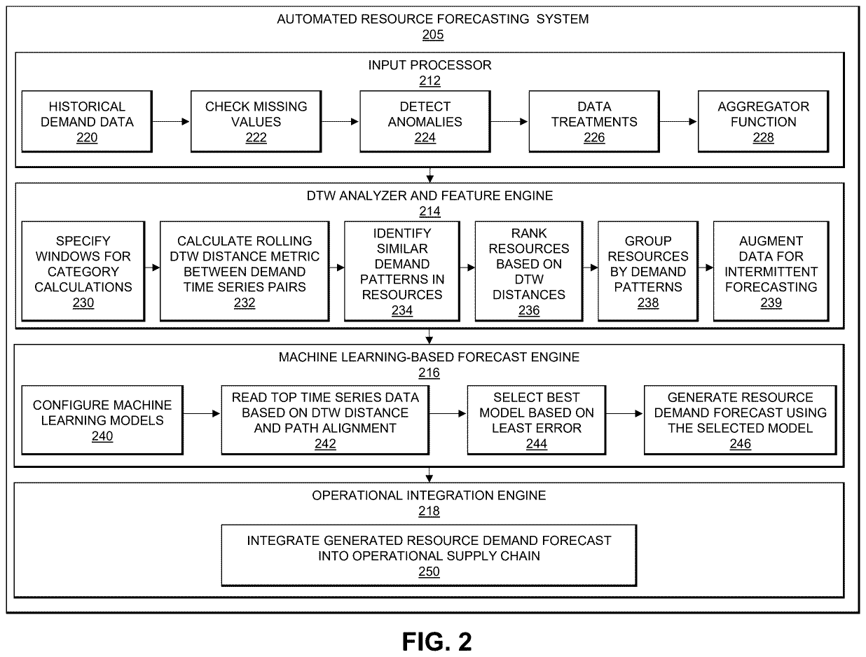

The automated resource forecasting system 105 further comprises an input processor 112, a DTW analyzer and feature engine 114, a machine learning-based forecast engine 116, and an operational integration engine 118. Descriptions of the functionalities of elements 112, 114, 116 and 118 are detailed further herein such as, for example, in connection with FIG. 2 below.

It is to be appreciated that this particular arrangement of elements 112, 114, 116 and 118 illustrated in the automated resource forecasting system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for implementing a machine learning-based resource forecasting system involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated resource forecasting system 105, resource demand-related data structures 107, and user devices 102 can be on and/or part of the same processing platform.

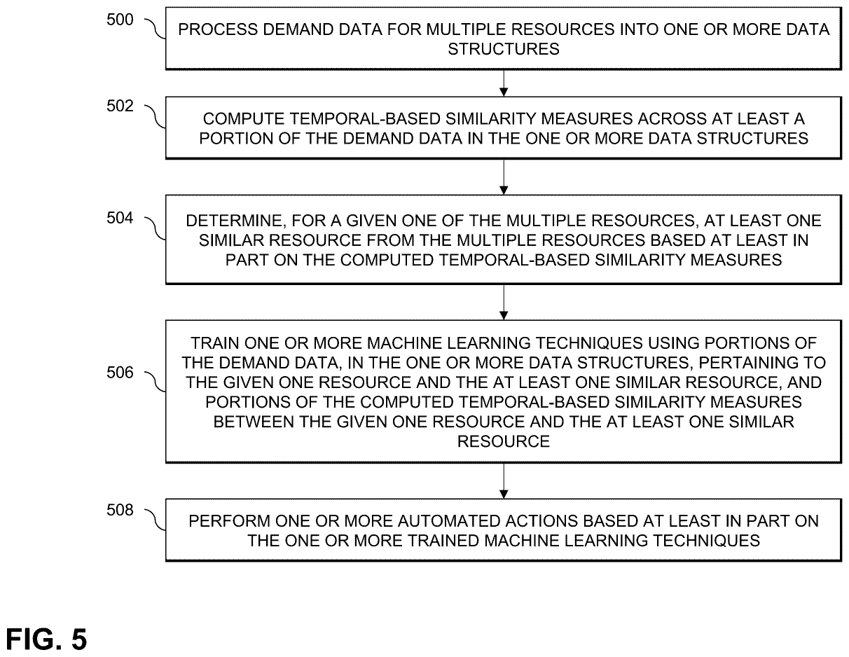

An exemplary process utilizing elements 112, 114, 116 and 118 of an example automated resource forecasting system 105 in computer network 100 will be described in more detail with reference to the flow diagram of FIG. 5.

Accordingly, at least one embodiment includes generating and/or implementing augmented intermittent resource demand forecasting using machine learning techniques in connection with DTW. As used herein, DTW broadly refers to a method used to compare data associated with two or more sequences which may vary in time and/or speed. Conventional resource forecasting techniques, as noted above and described herein, commonly fail to capably forecast resources associated with irregularities with respect to demand occurrence and/or demand quantity, leading to errors and resource wastage and/or loss. Accordingly, one or more embodiments include leveraging one or more metrics such as, e.g., distance and path alignments between a given resource (e.g., a hardware device or product) and one or more resources similar to the given resource to facilitate augmenting demand structure and/or signal of the corresponding time series data, which can then be processed using one or more machine learning models to determine and/or learn one or more underlying patterns, one or more temporal correlations, and/or one or more variations in demand occurrence for use in resource demand forecasting for the given resource.

As also used herein in connection with at least one embodiment, average demand interval (ADI) refers to a measure of demand regularity in time by computing the average interval between two demand occurrences. Additionally, the square of the coefficient of variation (CV²) refers to a measure of variation in demand quantities. Accordingly, in one or more embodiments, intermittent demand can be associated with an ADI value of greater than or equal to 1.32 and a CV² value of less than 0.49. More particularly, as used herein, intermittent resource demand refers to demand which shows limited variation in demand quantity but significant variation in the interval between two types and/or levels of demand. For example, intermittent demand can refer to a specific demand pattern with frequent periods of zero demand. Additionally, in such an embodiment, lumpy demand can be associated with an ADI value of greater than or equal to 1.32 and a CV² value of less than 0.49. More particularly, as used herein, lumpy demand is characterized by large variations in quantity and time.

As further detailed herein, at least one embodiment includes generating and/or implementing a resource forecast framework that integrates one or more time series forecasting methods with the application of one or more DTW metrics to address the unique challenges of forecasting for resources with intermittent demand patterns by leveraging one or more temporal relationships between different demand series. Such an embodiment includes utilizing at least one DTW-enabled feature engine that computes the similarity among different demand series across one or more resource categories and determines and/or selects the most similar demand series based at least in part on the demand-time alignment as well as the entire corresponding demand structure. At least one embodiment can also include computing at least one alignment path among demand series as to how many steps and/or units in time and speed are required to warp and/or merge two or more series to render the series similar.

As noted above and further detailed herein, metrics used as features from DTW to forecast intermittent demand patterns can include at least one distance metric and at least one alignment path metric. More particularly, a DTW distance metric can include the measure of dissimilarity between two time series, and can represent the cumulative distance between aligned elements of the two time series. A smaller DTW distance can indicate a greater similarity between the time series. Also, an alignment path metric can include a warping path found by the DTW algorithm, showing how elements in the two time series are matched. The alignment path can, for example, define the optimal alignment between the two time series, allowing for differences in timing and/or speed. In the context of enhancing the accuracy of intermittent demand forecasts, the above-noted DTW-derived metrics can be leveraged in one or more embodiments.

FIG. 2 shows an example workflow in accordance with an illustrative embodiment. By way of illustration, FIG. 2 depicts an example workflow carried out within automated resource forecasting system 205, and more particularly, within and across input processor 212, DTW analyzer and feature engine 214, machine learning-based forecast engine 216, and operational integration engine 218 of automated resource forecasting system 205.

As depicted in FIG. 2, the input processor 212 can host historical demand data 220 for various resources (e.g., hardware devices and/or products). Also, the input processor 212 can implement a preprocessing pipeline which can be linked to at least portions of input data to perform missing value checks in step 222, anomaly detection in step 224, and one or more data treatments in step 226. Further, the input processor can implement an aggregator function in step 228 that summarizes demand data to a desired level of granularity (weekly, monthly, etc.) for forecasting based at least in part on one or more related requirements. Such summarizations can also be utilized and/or implemented to render intermittent demand signals sufficiently stable in the data.

As also depicted in FIG. 2, the DTW analyzer and feature engine 214 specifies windows for category calculations in step 230, and calculates, in step 232, rolling DTW distance metrics between pairs of demand time series datasets (e.g., associated with resources within the same category or across categories, if relevant) over at least one specified temporal window. Such calculations can be used to identify, in step 234, which resources have one or more similar demand patterns, even if their demand peaks and troughs do not occur simultaneously. Also, the DTW analyzer and feature engine enables similarity assessments which can be used to rank resources, in step 236, based on their DTW distances relative to each other, and identify groups of resources with similar demand patterns in step 238. This, along with the alignment paths among similar demand time series, can be used to augment demand data for intermittent demand forecasting in step 239, as demand series with the most similar demand trajectories can prove a useful signal to be leveraged by the machine learning-based forecast engine 216.

Accordingly, in at least one embodiment, machine learning-based forecast engine 216 can host one or more time series datasets as well as one or more machine learning models that are trained to process past demand terms and one or more additional features as inputs. In step 240, one or more machine learning models (which can encompass a variety of deep forecasting models such as, e.g., at least one multilayer perceptron (MLP), at least one long short-term memory (LSTM) network, etc.) can be configured and/or incorporated in the machine learning-based forecast engine 216. Also, the machine learning-based forecast engine 216 can, in step 242, read and/or process past demand terms as well as DTW metrics (e.g., distance and path alignments) between a given demand time series dataset and one or more similar demand time series datasets in the hosted data. Accordingly, such metrics calculated from historical demand time series datasets can be leveraged for forecasting future resource demand. Further, in one or more embodiments, a given model (e.g., the best model), from an ensemble of models, can be identified and/or selected in step 244 for forecasting future demand for resources based at least in part on the lowest error value (e.g., the lowest mean absolute percent error (MAPE) value) measured between the generated forecast and the actual demand on a validation dataset. Further, the machine learning-based forecast engine 216 can use the selected model to generate, in step 246, one or more resource demand forecasts in connection with input data.

As also depicted in FIG. 2, the operational integration engine 218 can, in step 250, integrate at least a portion of the one or more resource demand forecasts generated via machine learning-based forecast engine 216 into one or more portions of a relevant and/or related operational supply chain environment. Additionally, in at least one embodiment, the operational integration engine 218 can also include a series of mechanisms for collecting feedback on forecast performance and refining and/or re-training the forecasting models based at least in part on such feedback and new demand data.

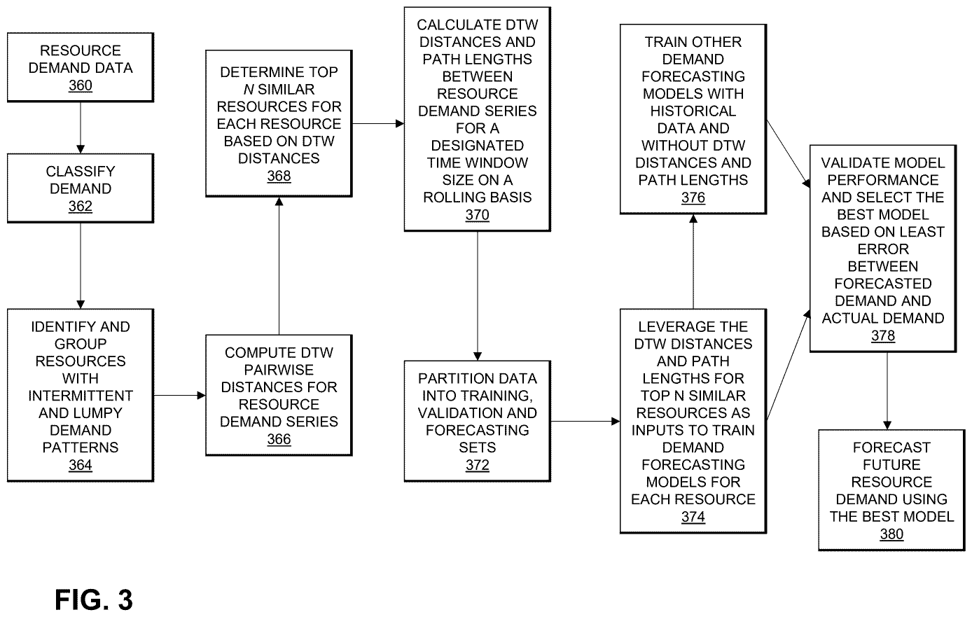

FIG. 3 shows an example workflow in accordance with an illustrative embodiment. By way of illustration, FIG. 3 depicts an example workflow carried out in connection with resource demand data 360. More particularly, step 362 includes classifying resources (e.g., hardware devices and/or products) within resource demand data 360 based at least in part on one or more demand patterns by calculating ADI and CV² values for the given resources. Step 364 includes identifying, and grouping into one or more subsets, resources with intermittent and/or lumpy demand patterns based at least in part on one or more designated empirical thresholds. Step 366 includes computing DTW distances between all pairs of resources in the demand data, and using such computations to generate at least one matrix of DTW distances (e.g., Euclidean distances, Manhattan distances, etc.) between each pair of resources, providing a measure of similarity between their demand patterns. Additionally, step 366 can also include computing, using the DTW function, the alignment path lengths in connection with the above-noted distance computations.

As also depicted in FIG. 3, step 368 includes determining and/or identifying, among at least a portion of the resources in the demand data, the top N most similar resources based at least in part on DTW distances. These resources can then serve as reference points for forecasting a given resource's future demand. Further, step 370 includes calculating rolling DTW metrics (e.g., distance and path length values) between the demand time series data of the given resource and the demand time series data of the identified top one or more most similar resources for a designated temporal window size. In one or more embodiments, such rolling DTW metrics can be used as exogenous variables to forecast demand for the given resource, and such calculations can encompass lagged demand alongside the above-noted factors.

Step 372 includes partitioning and/or splitting at least a portion of the demand data into one or more training sets, one or more validation sets, and one or more forecast sets, with the validation set representing the most recent demand observations for validating the performance of the forecasting model(s). In one or more embodiments, such forecasting models can include, for example, one or more gradient boosting models (e.g., XGBoost), one or more linear regression models, one or more MLPs, one or more LSTM networks, one or more Syntetos and Boylan approximation (SBA) models, one or more Croston models, etc. Additionally, step 374 includes training at least a portion of such models, with respect to the designated number of similar resources, for benchmarking the performance of models with DTW distances and path lengths, while step 376 includes training at least a portion of such models for benchmarking the performance of models without DTW distances and path lengths.

Further, step 378 includes validating the performance of at least a portion of the models with and without DTW metrics using the one or more validation datasets, and measuring the deviation of forecasted demand from actual demand using one or more metrics such as, e.g., MAPE. As used herein, MAPE measures the accuracy of a forecasting method in percentage terms by calculating the average absolute percentage difference between predicted values and actual values. The formula for calculating MAPE can be seen in Equation (1) as follows:

$$MAPE = \frac{1}{n} {\sum }_{i = 1}^{n} \vert \frac{{A}_{i} - {P}_{i}}{{A}_{i}} \vert \times 100 \qquad ( 1 )$$

wherein Aᵢ represents the actual value, Pᵢ represents the predicted value, and n represents the number of observations. As noted above, in one or more embodiments, MAPE values are expressed as percentages, and lower values indicate better accuracy.

Referring again to FIG. 3, step 380 includes identifying and using the one or more best forecasting models, determined via highest accuracy values and/or lowest MAPE values, for forecasting future demand for the given resource.

Accordingly, and as detailed herein, one or more embodiments include generating and implementing DTW metrics to augment and/or enhance intermittent demand forecasting. Such an embodiment includes incorporating DTW to leverage one or more temporal relationships between resources and/or demand data related thereto, as DTW assesses the similarity in demand patterns between resources, capturing alignments and/or discrepancies even when they occur at different times. This incorporation enables one or more forecasting models to leverage insights from resources with similar demand patterns, enhancing the accuracy of predictions for resources with intermittent and/or sporadic demand patterns.

Additionally, at least one embodiment includes calculating and incorporating rolling DTW metrics such as distance or similarity and path alignments between the target resource and one or more similar resources. Such an embodiment can include, for example, continuously updating the noted similarity measures over a specified window of recent data, rather than relying on a static measure calculated from a longer historical perspective. By focusing on recent data, the rolling window approach can dynamically adapt to one or more changes in user behavior and/or resource-related conditions. Accordingly, in such an embodiment, the forecasting process can be more responsive to recent trends, which can be critical for resources with intermittent demand wherein older data might be less indicative of current and/or future trends.

Further, one or more embodiments include incorporating one or more similarity metrics in resource demand forecasting. Beyond calculating DTW metrics, such an embodiment can include integrating such metrics as features into one or more machine learning-based forecasting models (e.g., gradient boosting, linear regression, etc.) by quantifying the impact of one or more temporal similarities on future resource demand. Also, the inclusion of one or more DTW-derived features into the feature space integrates inter-product, inter-demand series dynamics, which can provide insights into how resources relate to each other over time. Such insights can be incorporated to facilitate more informed and accurate resource demand predictions, particularly for resources with complex and/or non-linear demand patterns often found, for example, in intermittent demand pattern scenarios.

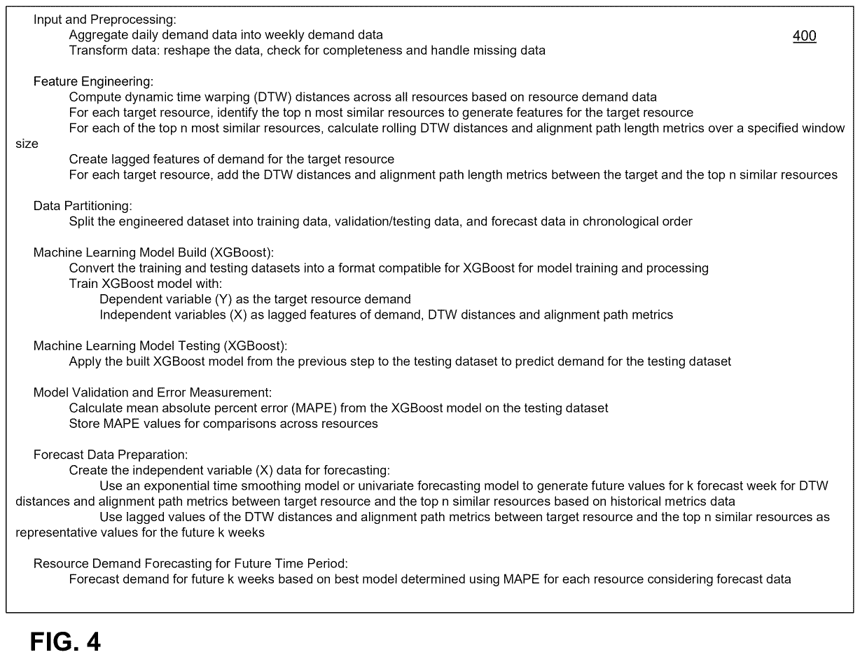

FIG. 4 shows example pseudocode for implementing at least a portion of a machine learning forecasting model in an illustrative embodiment. In this embodiment, example pseudocode 400 is executed by or under the control of at least one processing system and/or device. For example, the example pseudocode 400 may be viewed as comprising a portion of a software implementation of at least part of automated resource forecasting system 105 of the FIG. 1 embodiment.

The example pseudocode 400 illustrates input and preprocessing steps, feature engineering steps, data partitioning steps, machine learning model building steps, machine learning model testing steps, model validation and error measurement steps, forecast data preparation steps, and resource demand forecasting for future time period steps.

The input and preprocessing steps include aggregating daily demand data for a resource into weekly demand data to reduce data complexity, and transforming the aggregated data, including reshaping the data, checking for completeness in the data, and handling any missing data. The feature engineering steps include computing DTW distances across all designated resources based on their demand data. For each target resource, example pseudocode 400 includes identifying the top n most similar resources to generate features for the target resource. For each such similar resource, example pseudocode 400 includes calculating rolling DTW distances and alignment path length metrics over a specified window size (e.g., to capture dynamic similarities within moving time windows). The feature engineering steps also include creating lagged features of demand for the target resource (e.g., representing demand from the last week as lag1, demand from two weeks ago as lag2, etc.), and for each target resource, adding the DTW distances and alignment path length metrics computed between the target resource and the top n similar resources.

The data partitioning steps include splitting the dataset engineered in the above steps into a training dataset, a validation/testing dataset, and a forecast dataset in chronological order. The machine learning model (e.g., XGBoost) building steps include converting the training and testing datasets into a format compatible for XGBOOST (e.g., a DMatrix format) for efficient model training and processing. The machine learning model building steps also include training the XGBoost model with a dependent variable (Y) as the target resource demand and independent variables (X) as the lagged features of demand, DTW distances, and alignment path metrics between the target resource and the top n similar resources.

The machine learning model testing steps include applying the built XGBoost model from the previous steps to the testing dataset (including the lagged demand features of the target resource) to predict the resource demand for the testing dataset. The model validation and error measurement steps include calculating MAPE error metrics (which represent the mean of the absolute difference between the actual demand and the predicted demand from the XGBoost model on the testing dataset), and storing the MAPE values for comparisons across resources (e.g., and models thereof).

Further, the forecast data preparation steps include creating the independent variable (X) data for forecasting, which can include at least one of the following two approaches. The first approach includes using an exponential time smoothing model, a univariate forecasting model (e.g., an autoregressive integrated moving average (ARIMA) model, a TBATS model, etc.) and/or at least one other machine learning model to generate future values for k forecast weeks for DTW distances and alignment path metrics between the target resource and the top n similar resources based on historical metrics data (e.g., the DTW values from the training and testing datasets). The second approach includes using lagged values of the DTW distances and alignment path metrics between target resource and the top n similar resources as representative values for the future k weeks.

Additionally, the resource demand forecasting for future time period steps include forecasting the resource demand for the future k weeks based on the best model determined using the MAPE values for each resource, considering the prepared forecast data.

It is to be appreciated that this particular example pseudocode shows just one example implementation of at least a portion of a machine learning forecasting model, and alternative implementations can be used in other embodiments.

FIG. 5 is a flow diagram of a process for implementing a machine learning-based resource forecasting system with data structure processing in an illustrative embodiment. It is to be understood that this particular process is only an example, and additional or alternative processes can be carried out in other embodiments.

In this embodiment, the process includes steps 500 through 508. These steps are assumed to be performed by the automated resource forecasting system 105 utilizing elements 112, 114, 116 and 118.

Step 500 includes processing demand data for multiple resources into one or more data structures. In at least one embodiment, processing demand data includes classifying the multiple resources based at least in part on demand pattern by calculating one or more of average demand interval values and squared coefficient of variation values for the multiple resources. In such an embodiment, processing demand data can include identifying and grouping at least a portion of the multiple resources associated with one or more intermittent demand patterns based on at least one of one or more designated average demand interval value thresholds and one or more squared coefficient of variation value thresholds.

Step 502 includes computing temporal-based similarity measures across at least a portion of the demand data in the one or more data structures. In one or more embodiments, computing temporal-based similarity measures includes computing one or more dynamic time warping distances between one or more pairs of the multiple resources in the demand data. In such an embodiment, computing one or more dynamic time warping distances between one or more pairs of the multiple resources in the demand data can include determining at least one measure of similarity between demand patterns of the one or more pairs of resources by generating at least one matrix of dynamic time warping distances between the one or more pairs of resources. Additionally or alternatively, computing one or more dynamic time warping distances between one or more pairs of the multiple resources in the demand data comprises computing one or more rolling dynamic time warping distances between the one or more pairs of resources over at least one designated time window.

Further, in one or more embodiments, computing temporal-based similarity measures includes computing at least one dynamic time warping-based alignment path metric associated with one or more pairs of the multiple resources in the demand data.

Step 504 includes determining, for a given one of the multiple resources, at least one similar resource from the multiple resources based at least in part on the computed temporal-based similarity measures.

Step 506 includes training one or more machine learning techniques using portions of the demand data, in the one or more data structures, pertaining to the given one resource and the at least one similar resource, and portions of the computed temporal-based similarity measures between the given one resource and the at least one similar resource. In at least one embodiment, training one or more machine learning techniques includes training one or more machine learning-based forecasting models comprising at least one of one or more gradient boosting models, one or more linear regression models, one or more MLPs, one or more LSTM networks, one or more SBA models, and one or more Croston models.

Step 508 includes performing one or more automated actions based at least in part on the one or more trained machine learning techniques. In one or more embodiments, performing one or more automated actions includes generating at least one demand forecast for the given one resource using the one or more trained machine learning techniques and forecasted temporal-based similarity measures. Such an embodiment also includes automatically forecasting at least a portion of the temporal-based similarity measures for the given one resource and at least a portion of the multiple resources. To obtain such forecasted similarity measure values, at least one embodiment includes forecasting the values based at least in part on historical values and/or using lagged values as representative values for the future period in question.

Additionally or alternatively, performing one or more automated actions can include automatically integrating at least a portion of the at least one demand forecast for the given one resource into one or more operational systems related to the given one resource. In such an embodiment, automatically integrating at least a portion of the at least one demand forecast for the given one resource into one or more operational systems related to the given one resource includes automatically integrating the at least a portion of the at least one demand forecast for the given one resource into at least one system associated with the one or more machine learning techniques for re-training at least a portion of the one or more machine learning techniques based at least in part on feedback related to the at least one demand forecast and additional demand data for the given one resource. Additionally or alternatively, automatically integrating at least a portion of the at least one demand forecast for the given one resource into one or more operational systems related to the given one resource can include automatically integrating the at least a portion of the at least one demand forecast for the given one resource into one or more supply chain-related systems associated with the given one resource.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to implement a machine learning-based resource forecasting system DTW analysis and feature processing. These and other embodiments can effectively overcome problems associated with errors, inaccuracies, and resource wastage and/or loss.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

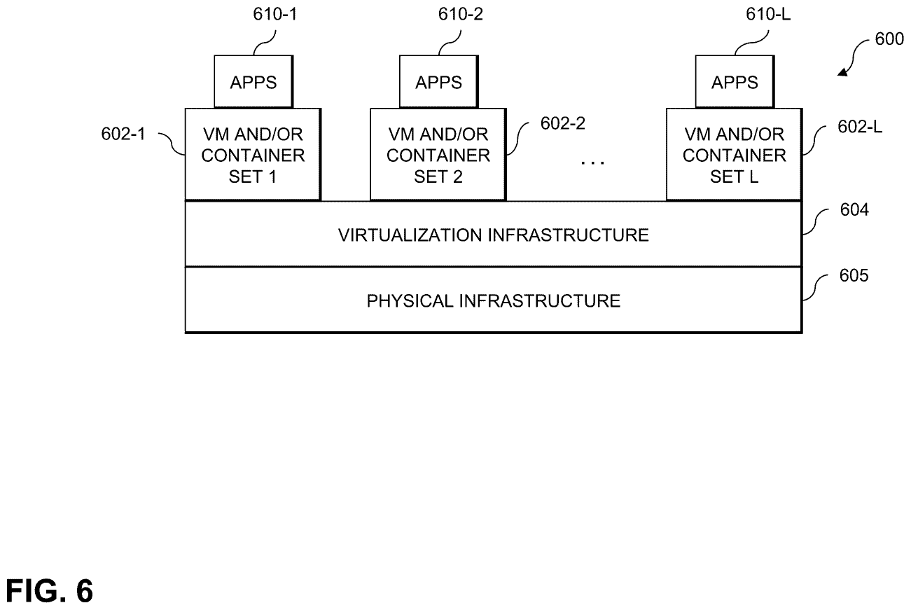

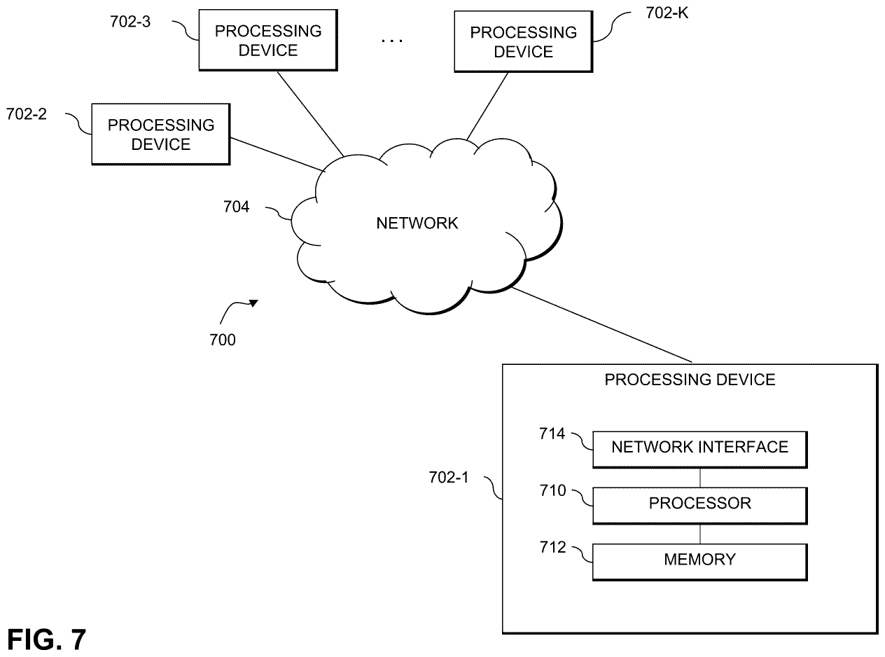

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 712 comprises RAM, ROM or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
processing demand data for multiple resources into one or more data structures;
computing temporal-based similarity measures across at least a portion of the demand data in the one or more data structures;
determining, for a given one of the multiple resources, at least one similar resource from the multiple resources based at least in part on the computed temporal-based similarity measures;
training one or more machine learning techniques using portions of the demand data, in the one or more data structures, pertaining to the given one resource and the at least one similar resource, and portions of the computed temporal-based similarity measures between the given one resource and the at least one similar resource; and
performing one or more automated actions based at least in part on the one or more trained machine learning techniques;
wherein the method is performed by at least one processing device comprising a processor coupled to a memory.

2. The computer-implemented method of claim 1, wherein performing one or more automated actions comprises generating at least one demand forecast for the given one resource using the one or more trained machine learning techniques.

3. The computer-implemented method of claim 2, wherein generating at least one demand forecast for the given one resource comprises automatically forecasting at least a portion of the temporal-based similarity measures for the given one resource and at least a portion of the multiple resources.

4. The computer-implemented method of claim 2, wherein performing one or more automated actions comprises automatically integrating at least a portion of the at least one demand forecast for the given one resource into one or more operational systems related to the given one resource.

5. The computer-implemented method of claim 4, wherein automatically integrating at least a portion of the at least one demand forecast for the given one resource into one or more operational systems related to the given one resource comprises automatically integrating the at least a portion of the at least one demand forecast for the given one resource into at least one system associated with the one or more machine learning techniques for re-training at least a portion of the one or more machine learning techniques based at least in part on feedback related to the at least one demand forecast and additional demand data for the given one resource.

6. The computer-implemented method of claim 4, wherein automatically integrating at least a portion of the at least one demand forecast for the given one resource into one or more operational systems related to the given one resource comprises automatically integrating the at least a portion of the at least one demand forecast for the given one resource into one or more supply chain-related systems associated with the given one resource.

7. The computer-implemented method of claim 1, wherein computing temporal-based similarity measures comprises computing one or more dynamic time warping distances between one or more pairs of the multiple resources in the demand data.

8. The computer-implemented method of claim 7, wherein computing one or more dynamic time warping distances between one or more pairs of the multiple resources in the demand data comprises determining at least one measure of similarity between demand patterns of the one or more pairs of resources by generating at least one matrix of dynamic time warping distances between the one or more pairs of resources.

9. The computer-implemented method of claim 7, wherein computing one or more dynamic time warping distances between one or more pairs of the multiple resources in the demand data comprises computing one or more rolling dynamic time warping distances between the one or more pairs of resources over at least one designated time window.

10. The computer-implemented method of claim 1, wherein computing temporal-based similarity measures comprises computing at least one dynamic time warping-based alignment path metric associated with one or more pairs of the multiple resources in the demand data.

11. The computer-implemented method of claim 1, wherein training one or more machine learning techniques comprises training one or more machine learning-based forecasting models comprising at least one of one or more gradient boosting models, one or more linear regression models, one or more multilayer perceptrons (MLPs), one or more long short-term memory (LSTM) networks, one or more Syntetos and Boylan approximation (SBA) models, and one or more Croston models.

12. The computer-implemented method of claim 1, wherein processing demand data comprises classifying the multiple resources based at least in part on demand pattern by calculating one or more of average demand interval values and squared coefficient of variation values for the multiple resources.

13. A non-transitory processor-readable storage medium having stored therein program code of one or more software programs, wherein the program code when executed by at least one processing device causes the at least one processing device:
to process demand data for multiple resources into one or more data structures;
to compute temporal-based similarity measures across at least a portion of the demand data in the one or more data structures;
to determine, for a given one of the multiple resources, at least one similar resource from the multiple resources based at least in part on the computed temporal-based similarity measures;
to train one or more machine learning techniques using portions of the demand data, in the one or more data structures, pertaining to the given one resource and the at least one similar resource, and portions of the computed temporal-based similarity measures between the given one resource and the at least one similar resource; and
to perform one or more automated actions based at least in part on the one or more trained machine learning techniques.

14. The non-transitory processor-readable storage medium of claim 13, wherein computing temporal-based similarity measures comprises computing one or more dynamic time warping distances between one or more pairs of the multiple resources in the demand data.

15. The non-transitory processor-readable storage medium of claim 13, wherein performing one or more automated actions comprises generating at least one demand forecast for the given one resource using the one or more trained machine learning techniques.

16. The non-transitory processor-readable storage medium of claim 15, wherein generating at least one demand forecast for the given one resource comprises automatically forecasting at least a portion of the temporal-based similarity measures for the given one resource and at least a portion of the multiple resources.

17. An apparatus comprising:
at least one processing device comprising a processor coupled to a memory;
the at least one processing device being configured:
to process demand data for multiple resources into one or more data structures;
to compute temporal-based similarity measures across at least a portion of the demand data in the one or more data structures;
to determine, for a given one of the multiple resources, at least one similar resource from the multiple resources based at least in part on the computed temporal-based similarity measures;
to train one or more machine learning techniques using portions of the demand data, in the one or more data structures, pertaining to the given one resource and the at least one similar resource, and portions of the computed temporal-based similarity measures between the given one resource and the at least one similar resource; and
to perform one or more automated actions based at least in part on the one or more trained machine learning techniques.

18. The apparatus of claim 17, wherein computing temporal-based similarity measures comprises computing one or more dynamic time warping distances between one or more pairs of the multiple resources in the demand data.

19. The apparatus of claim 17, wherein performing one or more automated actions comprises generating at least one demand forecast for the given one resource using the one or more trained machine learning techniques.

20. The apparatus of claim 19, wherein generating at least one demand forecast for the given one resource comprises automatically forecasting at least a portion of the temporal-based similarity measures for the given one resource and at least a portion of the multiple resources.
